(19) United States
(12) Patent Application Publication
(10) Pub. No.: US 2007/0251588 A1
(43) Pub. Date: Nov. 1, 2007

(54) Poppet valve

(76) Inventors: James C. Linder, Shorewood, MN (US); Mike Schleicher, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/414,129

(22) Filed: Apr. 27, 2006

(51) Int. Cl. F16K 11/044

(52) U.S. Cl. 137/625.5

(57) ABSTRACT

A three-way valve is disclosed having flow ports that are co-planar and a unitary actuation stem made of a material such as a fluoropolymer that is resistant to caustic fluids commonly used in the semiconductor industry. The three way valve does not require a diaphragm, and thus occupies a smaller footprint relative to standard diaphragm-type valves. The stem is designed to accommodate valving portions or “poppets” that can be assembled by hand, without need for special tooling. The valve body may also be made of a fluoropolymer, and may be either machined or molded to form.

### FIELD OF THE INVENTION

The present invention generally relates to valves. More particularly, this invention relates to three-way poppet style valves utilizing valve stems to control the flow of fluid between a common port and two other ports.

### BACKGROUND OF THE INVENTION

Various types of valves are used in the semiconductor industry to transport fluids, three-way valves that switch between alternate sources of fluids. It is important that the number of potential leak paths between the source paths be kept to a minimum due to the highly caustic nature of the fluids often used in the semiconductor industry. These valves must be made of materials highly resistant to the caustic fluids. Contact with metal parts is generally to be avoided. The components which contact the fluids are typically formed of fluoropolymers such as perfluoroalkoxy (PFA), polyvinylidene (PVDF), or polytetrafluoroethylene (PTFE).

Many three-way valves utilize a “diaphragm” to provide a barrier between the controlled fluids and the actuation mechanism of the valve. For purposes of this application, a “diaphragm” is hereby defined as a thin-walled, flexible sheet having a stationary outer perimeter and a central portion that flexes in a direction normal to a plane defined by the outer perimeter. The diaphragm may have concentric recesses or corrugations that reduce strain on the diaphragm when flexed. A concern with diaphragm-type valves is the life of the diaphragm. The diaphragms are preferably circular in shape to avoid stress concentration zones during flexing, and are typically three or more diameters relative to delivery conduits to reduce the strain on the diaphragm during actuation. Thus, diaphragm valves tend to have large footprints relative to the flow passageway being controlled.

Three-way valves, such as the model 704 pneumatic “stack valve” produced by Entegris, Inc. of Chaska, Minn., depicted in FIG. 1, are preferred over the diaphragm valves in many applications. Stack valves do not require bulky diaphragms, yet retain the flexibility of pneumatic actuation. The absence of a diaphragm allows for a compact, co-planar design that reduces the footprint of the valve. However, referring to FIG. 1, an existing stack valve assembly 10 utilizes a valve stem assembly 12 having a core stem 14 typically made of stainless steel or polyetheretherketone (PEEK) within a sleeve 16 made of polytetrafluoroethylene (PTFE) or some other material resistant to fluid streams 18, 20, 22 being controlled. The valve stem assembly 12 operates within a flow passage 24 of a valve body 26 to control the flow of fluid between a common passage 30 and two alternating passages 32 and 34. The sleeve 16 is press fit into contact elements or “poppets” 36 and 38 that are arranged to alternately isolate one of the two alternating passages 32 or 34 from fluid communication with the common passage 30, depending on the direction of actuation. Also, end caps 40 and 42 are press fit into the valve body 26 to seal off the interior chambers of the stack valve assembly 10.

The FIG. 1 design must rely on the integrity of various press fit components. A leak path 44 may develop between the sleeve and the core, with entry points at one of the press fit joints. Other leak paths 46 and 48 may develop at the press-fit joints the end caps 40 and 42, respectively. The integrity of the various press fit seals are difficult to test prior to service.

Another aspect of the configuration depicted in FIG. 1 is the need for special tooling to accomplish the press fit assembly. It is desirable to have a stem assembly that can be easily assembled and disassembled by hand, without need for special tooling and alignment procedures associated with the press fit operation.

There is a need for a three-way stack valve that does not rely on press fit components for containing the caustic fluids associated with semiconductor processes, and which can be quickly and easily assembled within the valve body portion with a minimal number of steps.

### SUMMARY OF THE INVENTION

A three-way valve having passages in a coplanar arrangement for use with caustic fluids such as those used in semiconductor processing applications is disclosed. The valve features a valve body and a unitary valve stem molded or otherwise formed from a fluoropolymer plastic material. The valve stem has two poppets, one formed integral with the valve stem, the other configured to mate with the valve stem in a “snap-on” arrangement. The snap-on arrangement eliminates the need for a press fit assembly of the wetted portions of the valve.

The various embodiments of the three-way valve invention include a body portion with a central axis, a first valve seat centered about the central axis and facing downward, a second valve seat positioned above the first valve seat, also centered about the central axis and facing upward, and a connecting passage extending between the valve seats. A lower cap portion may be attached to the body portion below the first valve seat, and an upper cap portion attached to the body portion above the second valve seat. An opening, aligned with the central axis, is provided in the upper cap portion to accommodate an actuation member. A common flow passage integral to the body portion is in fluid communication with the connecting passage. A first flow passage with a first axis of flow is integral to the body portion and is in fluid communication with the connecting passage through said first valve seat. A second flow passage with a second axis of flow is integral to the central body portion and is in fluid communication with the connecting passage through the second valve seat. A valve stem having a proximate end and a distal end extends through the first valve seat, connecting passage and second valve seat, with the proximate end of the valve stem attached to the actuation member. A first contact element is integrally formed on the valve stem and oriented to allow engagement with the first valve seat. A second contact element is formed to mechanically mate with the distal end of the valve stem and is oriented for engagement with the second valve seat. The central, common, first and second axes of flow are situated in a co-planar arrangement. Upward movement of the actuation member causes the first contact element to engage said first valve seat and isolate said first flow passage from fluid communication with the common flow passage. A downward movement of the actuation member causes said second contact element to engage said second valve seat and isolate said second flow passage from fluid communication with the common flow passage. The valve stem and first contact element may be comprised of the same material. Also, the material used for the stem and body portion may be of a fluoropolymer material.

A feature and advantage of certain embodiments of the invention relative to typical diaphragm-type three-way valves is that the source passages and common passage are co-planar, allowing the valve to be utilized in situations where space is at a premium. The present invention has this feature while retaining the flexibility that pneumatic actuation provides.

Yet another feature and advantage of specific embodiments of the invention relative to diaphragm-type valves is that there is no need for a diaphragm to control the valve thereby reducing the number of components, reducing assembly costs, and allowing the valve to occupy a smaller volume than current three-way valves.

A feature and advantage of various embodiments of the present invention relative to existing stack valve designs is a three-dimensional control contour assembly that is snap-fit together, allowing the valve core to be assembled quickly and efficiently without need for press fit tooling. As a result, the valve is less expensive to manufacture than present three-way valves.

Still yet another feature and advantage of specific embodiments of the invention is that the valve body may be molded rather than machined.

Another feature and advantage of specific embodiments of the invention is that the three-dimensional control contour can be quickly and easily removed from the connecting passage for replacement.

Further disclosure relating to plastic valves suitable for use in the semiconductor processing industry and for handling caustic fluids can be found in U.S. Pat. Nos. 5,335,696; 5,279,328; and U.S. application Ser. No. 08/843,456; now U.S. Pat. No. 5,924,441, all of which are assigned to the assignee of the instant invention. The two patents and the application are hereby incorporated by reference herein.

### BRIEF DESCRIPTION OF THE DRAWINGS

FIG. 1 is a drawing of a prior art three-way valve;

FIG. 2 is a perspective view of a three way valve according to the invention;

FIG. 3 depicts a three-way valve according to an embodiment of the invention;

FIG. 4 depicts a valve stem in an embodiment of the invention;

FIG. 5 illustrates an embodiment of a three-way valve according to the invention;

FIG. 6 illustrates a poppet as used in an embodiment of the present invention; and

FIG. 7 depicts a poppet as used in an embodiment of the present invention.

### DETAILED DESCRIPTION

It is noted that while the ensuing discussion describes various components as “upper” and “lower,” such descriptions are relational only; the embodiments disclosed do not require any particular orientation, nor do they require a certain portion of the valve be located above another portion.

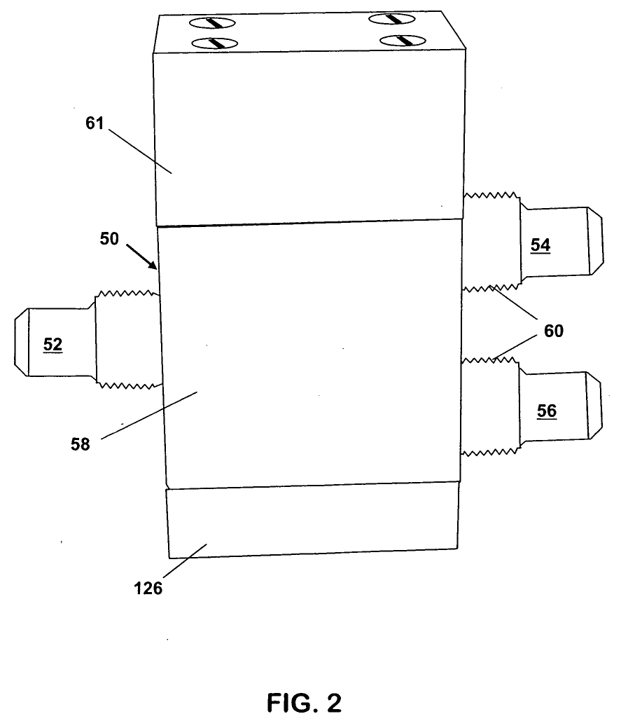

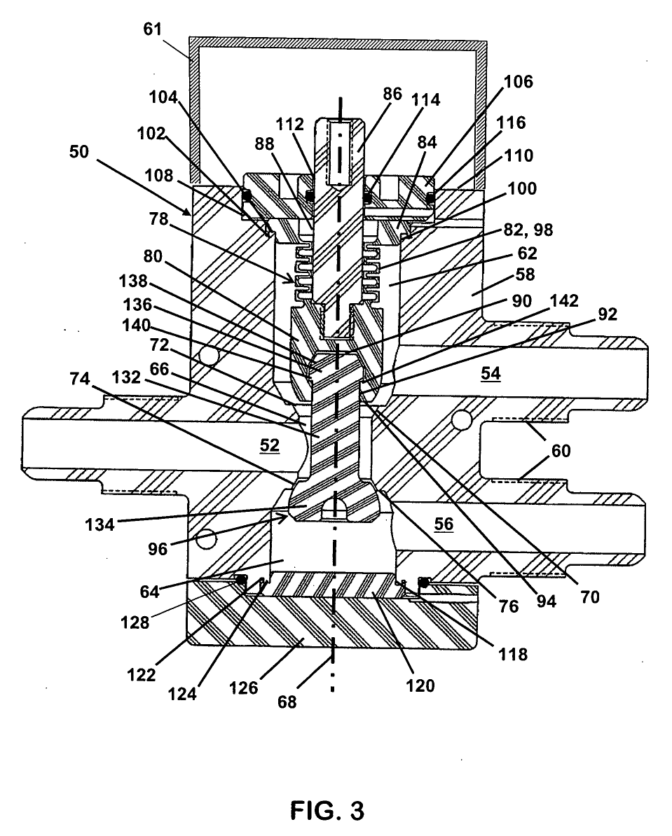

Referring to FIGS. 2 and 3, a configuration of a three-way stack valve 50 according to the present invention is presented in isometric projection in an upright orientation. The three-way stack valve 50 alternates the flow of fluid between a common passage 52 and either an upper passage 54 or a lower passage 56. The passages 52, 54 and 56 may be formed within a valve body 58 and may also have threads 60 formed thereon for coupling with external piping (not depicted). A covering 61 may be used to shroud the upper workings (discussed below) of the stack valve 50. The valve body 58 may be constructed of a fluoropolymer material through an injection molding and/or machining process.

The upper passage 54 expands into an upper chamber 62 also formed within the valve body. Likewise, the lower passage 56 diverges into a lower chamber 64. A connecting passage 66 generally centered about a central axis 68 establishes fluid communication between the upper and lower chambers 62 and 64. The connecting passage 66 is also in fluid communication with the common passage 52.

An upper valve seat 70 aligned with central axis 68 is situated at the bottom 72 of the upper chamber 62, thus forming a flow transition between the upper chamber 62 and the connecting passage 66. Likewise, a lower valve seat 74 aligned with central axis 68 is formed at an upper end 76 of the lower chamber 64, transitioning between the lower chamber 64 and the connecting passage 66.

The upper chamber 62 of the FIG. 3 embodiment contains an upper valve assembly 78 having an upper poppet portion 80, a flexible portion 82 and an upper cap portion 84. The upper valve assembly 78 may also be made from a fluoropolymer material selected for resistance to the caustic process fluids. There are certain advantages to selecting a material that is resilient, as will be evidenced by the discussion below.

The upper poppet portion 80 is aligned and configured to cooperate with the upper valve seat 70 to isolate the upper chamber 62 from the connecting passage 66 when the upper poppet portion 80 is seated against the upper valve seat 70. An actuating rod or member 86 is connected to the upper poppet portion 80, extending upward through the flexible portion 82 and through an access port 88 in the upper cap portion 84. A threadable connection between the actuating member 86 and the upper poppet portion 80 is portrayed in FIG. 3; however, any attachment means recognized by those skilled in the art may be utilized. The depiction of FIG. 3 also portrays the upper poppet portion 80 as having a female receptacle 90 with a mouth 92 on a lower face 94 of the upper poppet portion 80. The receptacle 90 is for receiving a lower valve assembly 96 (discussed below).

Preferably, the various portions 80, 82 and 84 of the upper valve assembly 78 are integral with each other, either being formed from a single continguous material, or fused or glued or otherwise joined permanently together, to form an impervious barrier between the fluid stream 18 and interior of the upper valve assembly 78 that houses the actuating member 86.

The FIG. 3 embodiment depicts the flexible portion 82 as having a bellows wall 98 that allows the upper poppet portion 80 to follow the actuating member 86 along central axis 68. The bellows wall 98 provides a flexible barrier between the interior of the upper valve assembly 78 and the fluid stream 18. As such, the bellowed wall 98 provides flexibility akin to a diaphragm, but within a smaller diameter or footprint. Other configurations for the flexible portion 82 may also be employed, such as an elastic sleeve, or a pair of concentric sleeves with a sliding seal therebetween, or other linearly extendible barriers known in the art.

The upper valve assembly 78 is suspended within the upper chamber 62 by mounting the upper cap portion 84 to the valve body 58 at an upper end 100 of the upper chamber 62. The upper cap portion 84 may be configured to seat within a radial groove 102 that cooperates with the upper chamber 62 to form a continuous lip 104 on the valve body 58 near the upper end 100 of the upper chamber 62. The upper cap portion 84 is secured in place by a plug 106 that is seated in a recess 108 on an upper surface 110 of the valve body 58. The plug 106 has an access port 112 aligned with the central axis 68 through which the actuating member 86 passes. 0-rings or other seals 114 and 116 are disposed within the access port 112 and at the interface between the perimeter of the plug 106 and the recess 108 to contain any fluid that may leak between the upper cap portion 84 and the valve body 58.

The lower chamber 64 is bounded on a lower end 118 by a lower end cap 120. The lower end cap 120 may be configured to seat within a radial groove 122 that, in conjunction with the lower chamber 64, forms a continuous lip 124 near the lower end 118 of the lower chamber 64. The lower end cap 120 is secured in place by a blind flange 126 connected to the valve body 58 (connection not depicted). An o-ring or other sealing means 128 is disposed between the blind flange 126 and the valve body 58 to contain any fluid that may leak between the lower end cap 120 and the valve body 58.

The lower valve assembly 96 includes a unitary stem 132 and a lower poppet portion 134. By “unitary,” it is meant that the stem 132 is formed from a single solid material, with no covering sleeve, such that the outer surface of the stem is in wetted contact with the process fluid being controlled. An upper portion 136 of the unitary stem 132 is formed to mate with the receptacle 90 of the upper poppet portion 80. The upper portion 136 of the unitary stem in the FIG. 3 configuration is depicted as having a male frustum portion 138 and a detent portion 140. If the upper poppet portion 136 is fabricated from a resilient material, the frustum portion 138 aids in the insertion of the lower valve assembly 96 into the female receptacle 90. During assembly, the male frustum portion 138 causes the mouth 92 of the female receptacle 90 to expand momentarily as the upper portion 136 passes through the mouth 92. Once the detent portion 140 passes through the mouth 92, the mouth 92 of the receptacle 90 elastically constricts or “snaps back” into place, and the detent portion 140 engages with an interior portion about the periphery 142 of the mouth 92 to secure the lower valve assembly 96 in place.

Accordingly, a “snap on,” “snap fit” or “snap together” assembly is hereby defined as one in which portions of a resilient female component elastically stretches or expands momentarily as a male component passes through or into the female component, the female component returning substantially to its original shape after the components are joined.

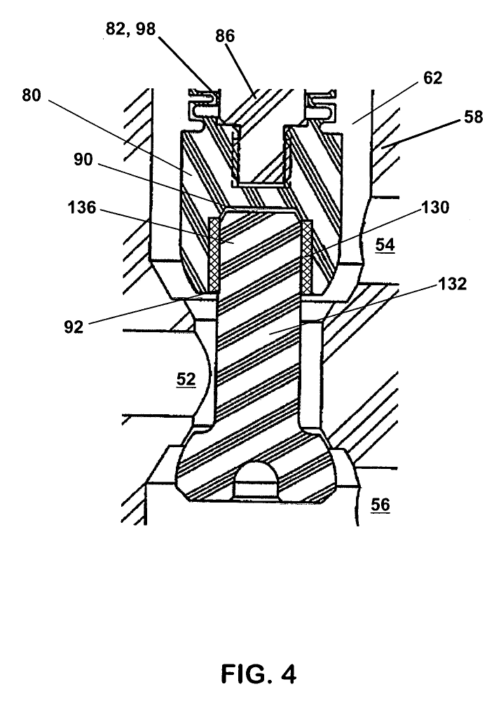

Alternatively, the receptacle 92 and the upper portion 136 of the unitary stem 132 may be threadably engaged, as illustrated in FIG. 4. Such a configuration precludes the “snap fit” assembly of the FIG. 3 embodiment, but is still conducive to hand assembly. A threadable engagement 130 is particularly suited for materials that lack resiliency.

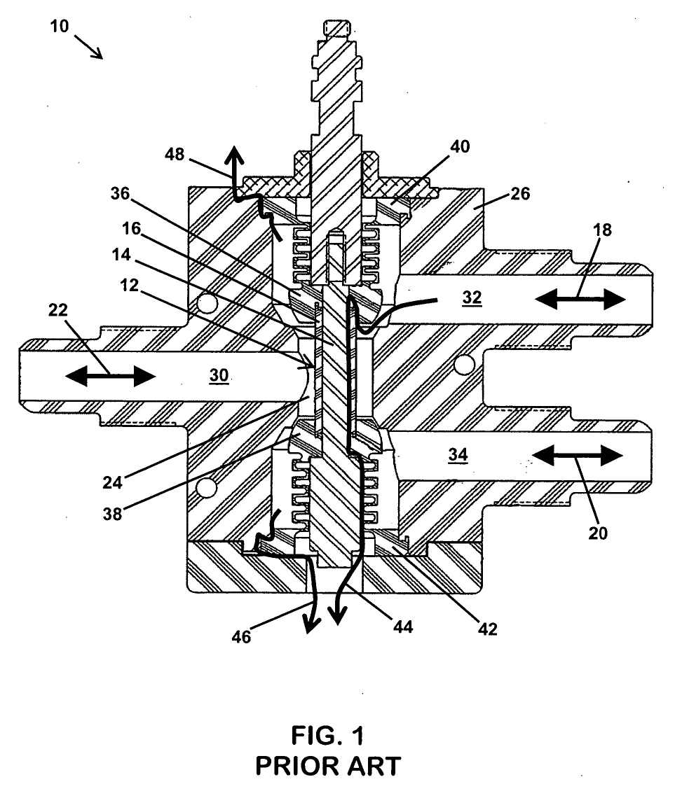

Preferably, the lower poppet portion 134 and the unitary valve stem 132 of FIG. 3 are integrally formed, but they may be formed separately and joined by fusing, threading or by other joining means known in the art. The lower valve assembly 96 is aligned and configured to cooperate with the lower valve seat 74 to isolate the lower chamber 64 from the connecting passage 66 when the lower poppet portion 134 is seated against the lower valve seat 74. Because the unitary valve stem 132 is formed from a single, corrosion resistant material, there is no need for the protective sleeve 16 depicted in FIG. 1; hence, there is no leak path that can form through the unitary valve stem 132.

The method of assembling the configuration of FIG. 3 is as follows: Provide a valve body 58 having formed therein an open upper chamber 62, an open lower chamber 64, a connecting passage 66 and a recess 108. Also provide an upper valve assembly 78, a lower valve assembly 96, a lower end cap 120, a blind flange 126, a plug 106 and an actuating member 86. Feed the actuating member 86 through the access port 88 of the upper cap portion 84 and the flexible portion 82 of the upper valve assembly 78, and attach the actuating member to the upper poppet portion 80. Place the upper valve assembly 78 into the upper chamber 62 and position the upper cap portion 84 so as to form a closure over the upper chamber 62. Secure the upper valve assembly 78 in place by sliding the access port 112 of the plug 106 over the actuating member 86 and into the recess 108, and fastening the plug 106 to the valve body 58. Feed the lower valve assembly 96 through the open lower chamber 64 and the connecting passage 64 so that the upper portion 136 of the unitary stem 132 is aligned with the mouth 92 of the receptacle 90 located on the lower end of the upper poppet portion 80. Exert a force against lower valve assembly 96 so that the frustum portion 138 of the upper portion 136 of the lower contact element 96 causes the mouth 92 of the receptacle 90 first to expand, then to snap back into place as the upper portion 136 of the unitary stem 132 passes through the mouth 92 of the receptacle 90. Position the lower end cap 120 so as to form a closure with the lower chamber 64. Secure lower end cap in place by connecting the blind flange 126 to the valve body 58.

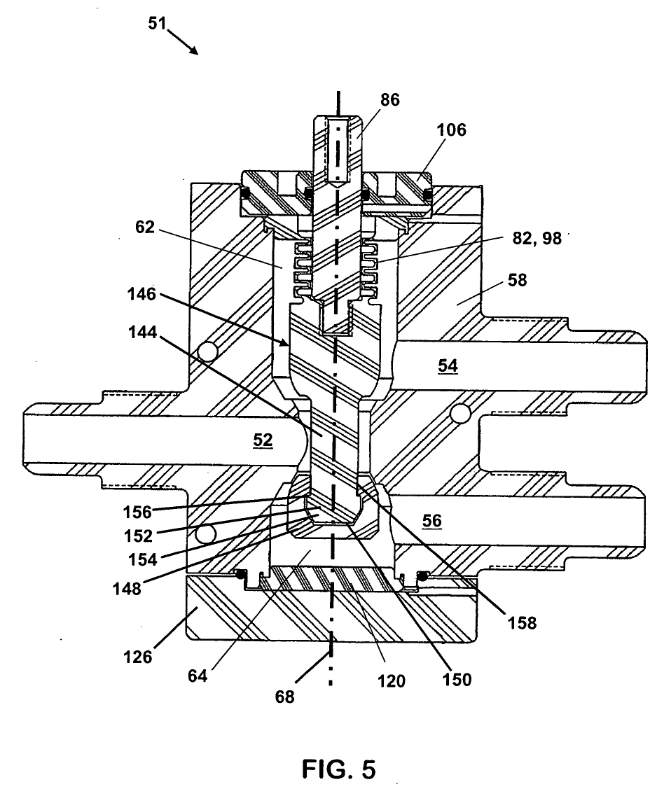

Referring to FIG. 5, an alternative stack valve configuration 51 is depicted wherein a unitary stem 144 is integral to an upper valve assembly 146 instead of a lower poppet portion 148. A receptacle 150 having a mouth 158 is formed within the lower poppet portion 148 and mates with the unitary stem 144 in the same manner as described for the FIG. 3 embodiment. The mating between the unitary stem 144 and the lower poppet portion 148 depicted in FIG. 5 has the same features as the corresponding mating parts in the FIG. 3 embodiment—namely, an end portion 152 having a frustum portion 154 for ease of assembly and a detent portion 156 to secure the unitary stem within the receptacle 150.

The method for assembling the configuration of FIG. 5 is as follows: Provide a valve body 58 having formed therein an open upper chamber 62, an open lower chamber 64, a connecting passage 66 and a recess 108. Also provide an upper valve assembly 78, a lower valve assembly 96, a lower end cap 120, a blind flange 126, a plug 106 and an actuating member 86. Feed the actuating member 86 through the access port 88 of the upper cap portion 84 and the flexible portion 82 of the upper valve assembly 78, and attach the actuating member 86 to the upper poppet portion 80. Place the upper valve assembly 78 into the upper chamber 62 with the unitary stem 144 substantially centered within the connecting passage 66. Position the upper cap portion 84 so as to form a closure over the upper chamber 62. Secure the upper valve assembly 78 in place by sliding the access port 112 of the plug 106 over the actuating member 86 and into the recess 108 and fastening the plug 106 to the valve body 58. Through the open end of the lower chamber 64, align the mouth of the receptacle 150 with the end portion 152 of the unitary stem 144. Apply a force against lower poppet portion 148 so that the frustum portion 154 on the end portion 152 of the unitary stem 144 causes the mouth 158 of the the receptacle 150 first to expand, then to snap back into place as the end portion 152 of the unitary stem 144 passes through the mouth 158 of the receptacle 150. Position the lower end cap 120 so as to form a closure with the lower chamber 64. Secure lower end cap in place by connecting the blind flange 126 to the valve body 58.

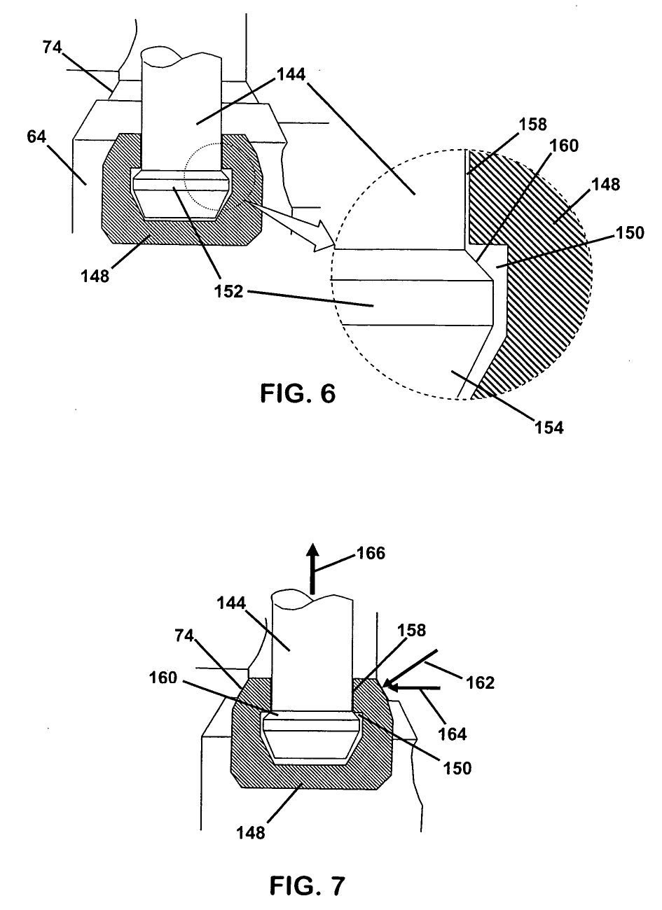

Referring to FIGS. 6 and 7, the FIG. 5 embodiment can be exploited for easy disassembly by implementing a few modifications. Specifically, FIG. 6 depicts an end portion 152 of the unitary stem 144 having no detents. Instead, the detents are eliminated in favor of an inclined surface 160 that may have an angle substantially similar to the angle of the surface of the frustum portion 154 that transitions between the unitary stem 144 and the end portion 152 of the unitary stem 144. When the lower chamber 64 is in an “open” position (i.e. is not seated against the lower valve seat 74), as depicted in FIG. 6, removal of the lower poppet 148 is augmented by the inclined surface 160. The inclined surface 160 will cause the mouth 158 of the receptacle 150 to widen as the end portion 152 passes through the mouth, according to the same dynamic as the “snap on” of the poppet during assembly. However, when the lower poppet 148 is seated in the “closed“position (i.e. is seated against the lower valve seat 74) by a seating force 166 as depicted in FIG. 7, a reaction force 162 having a radial inward component 164 is exerted against the lower poppet 148 that prevents the inclined surface 160 from expanding the mouth 158 of the receptacle 150; hence, detents are not necessary to secure the lower poppet 148 in the FIG. 6 embodiment.

Accordingly, the lower poppet 148 in FIG. 6 may be readily removed by grasping the lower poppet 148 when the lower chamber 64 is open to the connecting passage 66 and pulling the lower poppet 148 off the end portion 152 of the unitary stem 144. Once lower poppet 148 has been removed, the stack valve assembly 50 may be readily disassembled by removing the lower blind flange 126 and the plug 106.

The present invention may be embodied in other specific forms without departing from the spirit or essential attributes thereof, and it is therefore desired that the present embodiment be considered in all respects as illustrative and not restrictive.

What is claimed is:

1. A three-way valve assembly comprising:
a first flow passage having a first axis of flow;
a second flow passage having a second axis of flow;
a common flow passage having a common axis of flow;
a connecting passage having a central axis, said connecting passage being in fluid communication with said first, second and common flow passages,
a valve seat substantially centered about said central axis and forming a transition between said connecting passage and said first flow passage;
a valve stem having a first end portion and a second end portion, said first end portion configured to threadably engage or snap together with a contact element,
said contact element having a first end portion and a second end portion, said first end portion of said contact element being configured to engage said valve seat;
wherein said central, common, first and second axes of flow are substantially co-planar;
wherein movement of said valve stem in a first direction causes said contact element to engage said valve seat and movement of said valve stem in a second direction causes said contact element to move away from said valve seat; and
wherein said three-way valve assembly does not utilize a diaphragm.

2. The three way valve assembly of claim 1 wherein said valve stem is unitary.

3. The three-way valve assembly of claim 1, further comprising
an flexible portion extending axially from said second end portion of said valve stem; and
an actuating member extending through said flexible portion and being connected to said second end portion of said valve stem,
wherein said flexible portion accommodates movement of said actuating member in a direction parallel to said central axis while providing fluid isolation between said actuating member and said second flow passage.

4. The three-way valve assembly of claim 3, wherein said flexible portion is a bellows.

5. The three-way valve assembly of claim 1, further comprising
an flexible portion extending axially from said second end portion of said contact element; and
an actuating member extending through said flexible portion and being connected to said second end portion of said contact element,
wherein said flexible portion accommodates movement of said actuating member in a direction parallel to said central axis while providing fluid isolation between said actuating member and said first flow passage.

6. The three-way valve assembly of claim 5, wherein said flexible portion is a bellows.

7. A three-way valve for controlling the flow of a process fluid or fluids, comprising:
a body portion having a connecting passage;
a valve seat in fluid communication with said connecting passage;
a valve stem having an end portion and extending through said valve seat,
a contact element formed to snap together with or threadably engage said end portion of said valve stem, said contact element configured to engage said valve seat;
said unitary valve stem having an outer surface in direct contact with said process fluids;
such that movement of said valve stem in a first direction causes said contact element to engage said valve seat, and movement of said valve stem in a second direction causes said contact element to move away from said valve seat.

8. A three-way valve comprising:
a fluoropolymer body having a connecting passage, a first flow passage, a second flow passage and a common flow passage formed therein,
said connecting passage being in fluid communication with said first, second and common flow passages;
a unitary fluoropolymer valve stem extending into said body portion;
wherein movement of said valve stem in a first direction causes said first flow passage to become isolated from fluid communication with said common and said second flow passages, and movement of said valve stem in a second direction causes said second flow passage to become isolated from fluid communication with said common and said first flow passages.

9. A method of assembling a three-way valve, comprising the steps of providing a valve body having:
a first end and a second end;
a first chamber accessible from said first end of said valve body;
a second chamber accessible from said second end of said valve body;
a connecting passage establishing fluid communication between said first and said second chambers;
providing a contact element and a valve stem, said valve stem having a first end portion, said first end portion and said contact element being configured to snap together;
insert said valve stem portion through said first chamber and into said connecting passage, so that said first end portion of said valve stem protrudes into said second chamber;
push said contact element onto said first end portion until said contact element snaps on to said first end portion of said valve stem.
